(19) United States
(12) Patent Application Publication
(10) Pub. No.: US 2013/0282817 A1
(43) Pub. Date: Oct. 24, 2013

(54) Targeting Media Based on Viewer Attributes and Elements

(71) Applicants: Gerard J. Montgomery, Advance Mills, VA (US); Richard S. Okin, South Orange, NJ (US)

(72) Inventors: Gerard J. Montgomery, Advance Mills, VA (US); Richard S. Okin, South Orange, NJ (US)

(21) Appl. No.: 13/849,182

(22) Filed: Mar. 22, 2013

Related U.S. Application Data
(60) Provisional application No. 61/614,328, filed on Mar. 22, 2012.

(51) Int. Cl. H04L 29/08

(52) U.S. Cl. CPC H04L 67/22
USPC 709/204

(57) ABSTRACT

The present disclosure generally relates to a method comprising receiving, by a computer device comprising a processor and a memory in communication with the processor, at least one profile describing a viewer type likely to be interested in a first content, receiving, by the computer device, a plurality of elements, and determining, by the computer device, at least one element of the plurality of elements likely to be of interest to a potential viewer associated with the at least one profile by mapping the at least one profile to the plurality of elements. Another embodiment comprises a computer-readable medium comprising processor-executable software program code for carrying out such a method. Another embodiment comprises a system comprising a processor and a memory in communication with the processor, the memory comprising processor-executable computer program code for carrying out such a method.

### REFERENCE TO RELATED APPLICATION

This application claims priority to U.S. Provisional Patent Application No. 61/614,328, entitled “Targeting Media Based on Viewer Attributes and Elements,” filed Mar. 22, 2012, the entirety of which is hereby incorporated by reference.

### FIELD

The present disclosure relates to methods and systems for targeting delivery of content to viewers.

### BACKGROUND

Historically, Internet advertising has involved the display of advertising content on various different types of web sites. A person or business wishing to advertise on the Internet makes arrangements for one or more web sites to display advertising content for the person or business. Such arrangements are typically made through a third party Internet advertising firm. The web sites, and the Internet advertising firm, are compensated by the person or business, for example, based on the number of unique viewers who perform some action relative to the advertising content such as, viewing the content, “clicking-through” the content, otherwise interacting with the content, etc. According to typical methods, targeting the placement of advertising content simply requires selecting web sites that the desired viewer type tends to visit and presenting ads that appeal to the viewer.

Social media sites, such as FACEBOOK, TWITTER, GOOGLE+, LINKEDIN, FOURSQUARE, STUMPLEUPON, etc. have led to different models for placing Internet advertisements. Some of these new models are based on features that allow users to indicate their interest in and/or approval of certain people and things. One example of such a feature is the LIKE feature of FACEBOOK. Users can use the LIKE feature, and other similar features, to indicate their approval of certain people and things. Additionally, since many social media sites have a huge amount of information regarding their user's profiles, these sites offer much more granular ways to target the interests of their user community for advertising purposes. Social media sites often sell advertising based on the ability to target interests. For example, some social media sites sell the right to provide advertising content (or other content) to users that have interest in particular people and things. In addition to standard types of targeting options, these social media vendors also provide the ability to target by interest, with the price of each interest depending on demand for the interest, and other factors. Since this granular interest-level targeting is perceived to be a more powerful method for reaching customers, it is a considerable challenge for advertisers and other content providers to select and purchase the interests in a cost effective manner. Popular interests may provide desired exposure for advertising content, but at increased cost. Less popular interests are less expensive, but fail to provide desired exposure.

### SUMMARY

The present disclosure generally relates to a method comprising receiving, by a computer device comprising a processor and a memory in communication with the processor, at least one profile describing a viewer type likely to be interested in a first content, receiving, by the computer device, a plurality of elements, and determining, by the computer device, at least one element of the plurality of elements likely to be of interest to a potential viewer associated with the at least one profile by mapping the at least one profile to the plurality of elements. Another embodiment comprises a computer-readable medium comprising processor-executable software program code for carrying out such a method. Another embodiment comprises a system comprising a processor and a memory in communication with the processor, the memory comprising processor-executable computer program code for carrying out such a method.

Illustrative and example embodiments disclosed herein are mentioned not to limit or define the invention, but to provide examples to aid understanding thereof. Illustrative embodiments are discussed in the Detailed Description and further description of the invention is provided therein. Advantages offered by various embodiments of this invention may be further understood by examining this specification.

### BRIEF DESCRIPTION OF THE DRAWINGS

FIG. 1 is a diagram of one example embodiment of an environment showing various computer devices that may be utilized to identify elements-of-interest.

FIG. 2 is a diagram of one example embodiment of the targeting server and data storage of FIG. 1.

FIG. 3 is a flow chart showing one embodiment of a process flow for generating one or more viewer profiles and mapping the viewer profiles to element data to identify elements-of-interest.

FIG. 4 is a diagram showing a workflow, according to one embodiment, for viewer profile generation illustrated in the process flow of FIG. 3, including examples of data types.

FIG. 5 is a diagram showing a workflow, according to one embodiment, for generating one or more viewer profiles and mapping the viewer profiles to element data to identify elements-of-interest.

FIG. 6 is a flow chart showing one embodiment of a process flow for mapping one or more viewer profiles to element data to identify elements-of interest.

FIG. 7 is a flow chart showing one embodiment of a process flow for generating elements.

FIG. 8 is a diagram showing one example embodiment a hierarchy of elements.

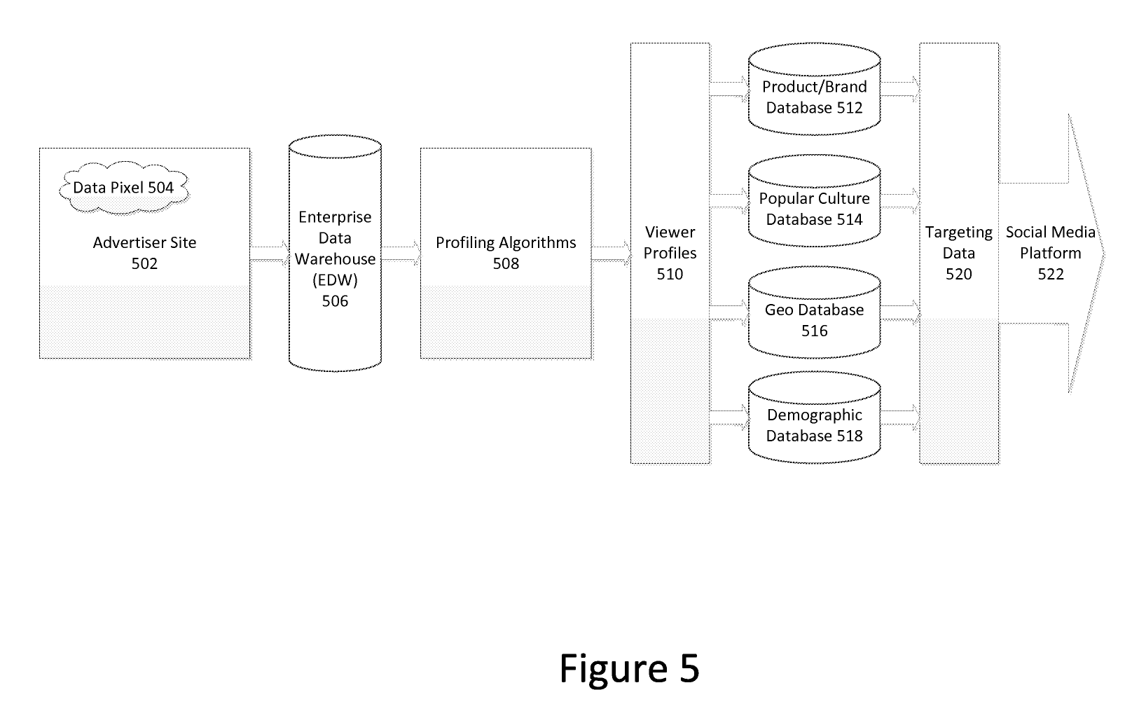

FIG. 5A is a diagram showing another example embodiment of a hierarchy of elements.

FIG. 9 is a diagram showing an example implementation of a process for determining elements-of-interested based on a viewer profile.

### DETAILED DESCRIPTION

Various example embodiments are directed to systems and methods for targeting the delivery of content, such as advertising content. The targeting may include identifying targeting data, where the targeting data describes elements-of-interest that are likely to be of interest to a targeted group of viewers (e.g., elements that the targeted group of users is likely to “like” or otherwise indicate interest). Accordingly, an advertiser (e.g., an Internet advertising firm) can use the elements-of-interest when determining which elements to purchase in order to reach the targeted group of viewers. In some example embodiments, the elements-of-interest include elements that are not easily identified as reaching the targeted group of viewers. These elements may be particularly desirable for purchase as they are often less expensive than more popular elements.

An element, as used herein, may refer to anything in which a viewer can express and/or otherwise indicate an interest. Elements may include people and things such as, for example, celebrities, athletes and other sporting figures, sporting teams, government leaders and institutions, movies, products, geographic locations, etc.

The systems and methods described herein may receive as input one or more viewer profiles describing a type of viewer (e.g., viewer type) that is likely to be interested in a particular type of content, as well as a plurality of elements, such as elements that viewers may “like” or otherwise indicate interest. The viewer profiles may be mapped to the elements, as described herein below, to identify the elements-of-interest (e.g., elements that are currently relevant and likely to be “liked” or otherwise indicated by viewers of the viewer profile).

Viewer profiles may include data describing attributes of viewers that are likely to be interested in the content (e.g., advertising content) to be delivered. Such attributes may include an age or range of ages, an income level or range of income levels, a gender, a geographic location, etc. The viewer profiles may be generated in any suitable manner. For example, in some example embodiments, the viewer profiles are pre-generated profiles that may have been generated earlier and/or purchased from a third party provider. Also, in some example embodiments, viewer profiles dedicated to a particular content or content-type are generated automatically by tracking the activities of viewers known to have interest in the content-to-be-delivered, as described herein.

Referring now to the plurality of elements, each element may be described by at least one demographic tag and an indication of relevance. Generally, demographic tags for each element indicate attributes of viewers that are likely to have an interest in the element (and thereby “like” the element or otherwise indicate their interest). The attributes of the demographic tags may be similar to the attributes associated with the viewer profiles described above. For example, different demographic tags may describe an age or range of ages, an income level or range of income levels, a gender, a geographic location, etc. In one example illustration, an element corresponding to the movie “Titanic” comprises demographic tags indicating women between the ages of 18 and 35. Another example element, “Ford Mustang,” may comprise demographic tags indicating men between the ages of 18 and 50 who live in rural or suburban areas. The relevance of an element may indicate a general likelihood that viewers having an interest in the element will “like” the element or otherwise indicate their interest. In various example embodiments, the relevance of an element varies based on time. For example, the relevance of the “Titanic” element from above may be high when the Titanic, or related elements, are in the news, such as near the one hundredth anniversary of the Titanic tragedy, and decay afterwards. Also, the relevance of the example element “Ford Mustang” may be high when Mustangs are in the news (e.g., when new models) are released, but, may decay afterwards. For some elements, relevance is specific to a demographic tag or set of demographic tags. For example, the element “Titanic” may have a high relevance to women, and a lesser relevance to men. In some example embodiments, as described herein, relevance may be modified after construction of a set of elements, for example, based on current events and/or on the interconnections and interactions amongst the complete set of elements.

In some example embodiments, the plurality of elements is arranged into a hierarchal structure where some elements depend from other elements. A dependent element may have demographic tags and/or relevance properties that are inherited or propagated down from its parent. Some dependent elements also have additional demographic tags that stand on their own. Also, some elements can depend from multiple parent elements. For example, an actor may inherit demographic tags from each movie in which the actor has appeared. For purposes of illustration, the element “Titanic” from above may have dependent elements corresponding to other people and things related to the movie Titanic such as, for example, actors and actresses (Leonardo DiCaprio and Kate Winslet), musical artists featured in the movie (Celine Dion), the director (James Cameron), etc. It will be appreciated that viewers likely to be interested in the movie Titanic may also be interested in these and other dependent elements. Similarly, the relevance of the dependent elements may also track that of the parent element. In the Mustang example, dependent elements may include the company that builds the Mustang (Ford Motor Company) people associated with the Mustang (Caroll Shelby, Steve Sateen, etc.) and more.

Reference will now be made in detail to several embodiments, examples of which are illustrated in the accompanying figures. Wherever practicable similar or like reference numbers may be used in the figures and may indicate similar or like functionality. The figures depict example embodiments of the disclosed systems (or methods) for purposes of illustration only. One skilled in the art will readily recognize from the following description that alternative example embodiments of the structures and methods illustrated herein may be employed without departing from the principles described herein.

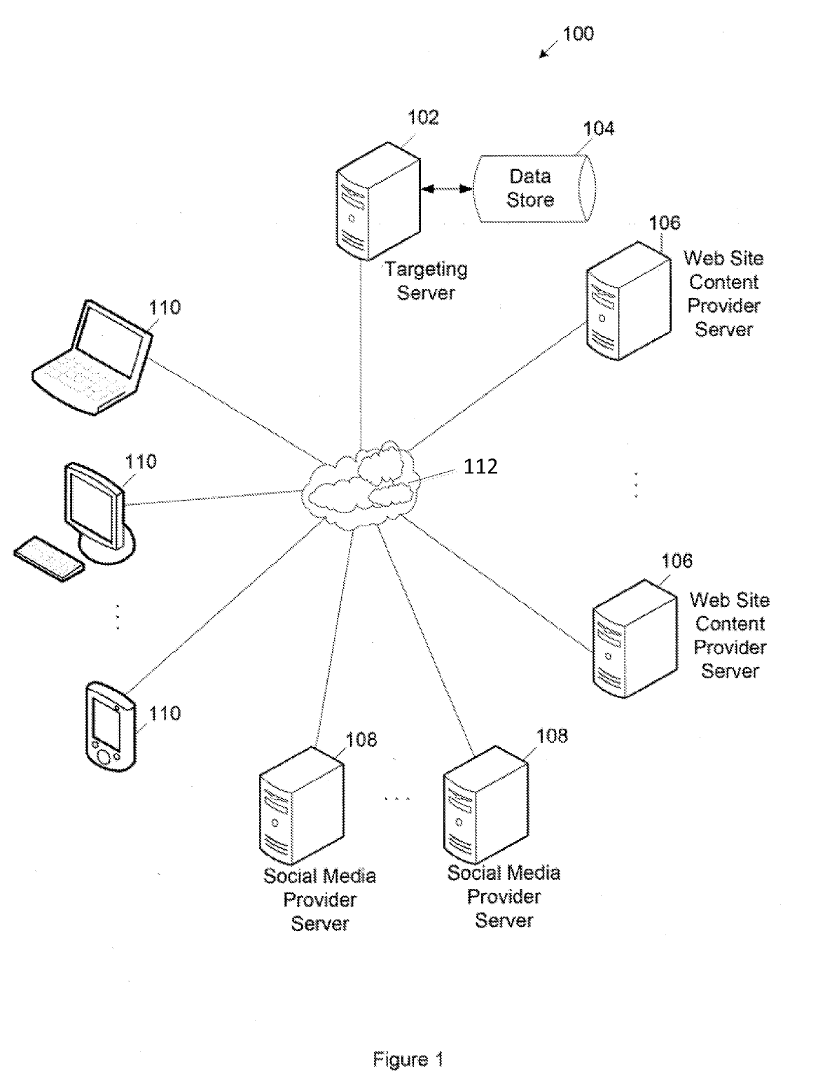

FIG. 1 is a diagram of one example embodiment of an environment 100 showing various computer devices that may be utilized to identify elements-of-interest. The targeting server 102 may comprise one or more computer devices individually and/or collectively programmed to identify elements-of-interest, as described in more detail herein. The targeting server 102 may be in communication with one or more data stores, such as the data store 104. Viewer devices 110 may be utilized by viewers to view Internet content, including media content as well as advertising content. Viewer devices 110 may include any suitable type of device utilized by viewers to access Internet content including, for example, desktop computers, laptop computers, smart phones, tablets, etc. The content may be provided to the viewers via one or more web content provider servers 106. Social media provider servers 108 may also provide web content to viewers (via viewer devices 110). Social media provider servers 108, however, may provide functionality allowing viewers to “like” or otherwise indicate interest in various elements. For example, social media provider servers 108 may sell the right to provide content (e.g., advertising content) to viewers through the social media provider servers 108 based on elements “liked” by the viewers, as described herein. The various components of the environment 100 communicate with one another via a network 112. The network 112 may be and/or comprise any suitable form of wired and/or wireless network and, in some embodiments, includes the Internet.

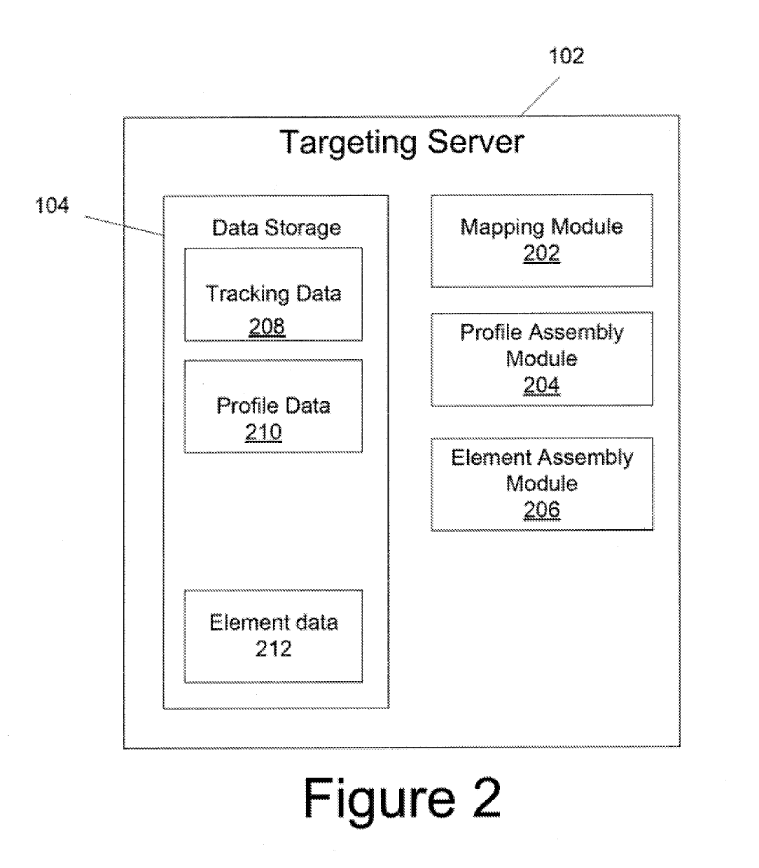

FIG. 2 is a diagram of one example embodiment of the targeting server 102 and data storage 104. In the illustrated example, the targeting server 102 comprises several functional modules including a mapping module 202, a profile assembly module 204 and an element assembly module 206. The functional modules may represent hardware and/or software components programmed to perform the actions described herein. For example, the mapping module 202 may map one or more viewer profiles onto one or more elements, as described herein, to identify elements-of-interest e.g., elements that are likely to be of interest to viewers meeting the viewer profile). The profile assembly module 204 may assemble profiles, for example, based on viewer tracking data as described herein. The element assembly module 206 may assemble elements, for example, by setting and/or refining element dependencies and determining demographic tags and relevance indications for the elements.

The data storage 104, as illustrated in the example of FIG. 2, comprises various data utilized by the targeting server 102 to perform the tasks described herein. Viewer tracking data 208 may be utilized, for example, by the profile assembly module 204 to assemble viewer profiles. Profile data 210 may describe viewer type profiles. Example profile types include viewer-based profiles, geography-based profiles, mixed profiles, etc. Element data 212 may describe elements including, for example, at least one demographic tag and an indication of relevance for each element. The element assembly module 206 may be utilized to generate the element data 212. The element data 212 and various profile data 210 may be utilized by the mapping module 202, as described herein.

It will be appreciated that the targeting server 102, as illustrated in FIGS. 1 and 2, may comprise one or more than one computer devices at a single location, or distributed across multiple locations. Also, it will be appreciated that some example embodiments omit some of the modules and data types shown in FIG. 2. For example, when profile data 210 and element data 212 are received in pre-configured form, the profile assembly module 204, element assembly module 206, and tracking data 208 may be omitted. Also, in some embodiments, the tracking server 102 performs intermediate actions towards identifying elements. For example, in some example embodiments, the mapping module 202 may also be omitted.

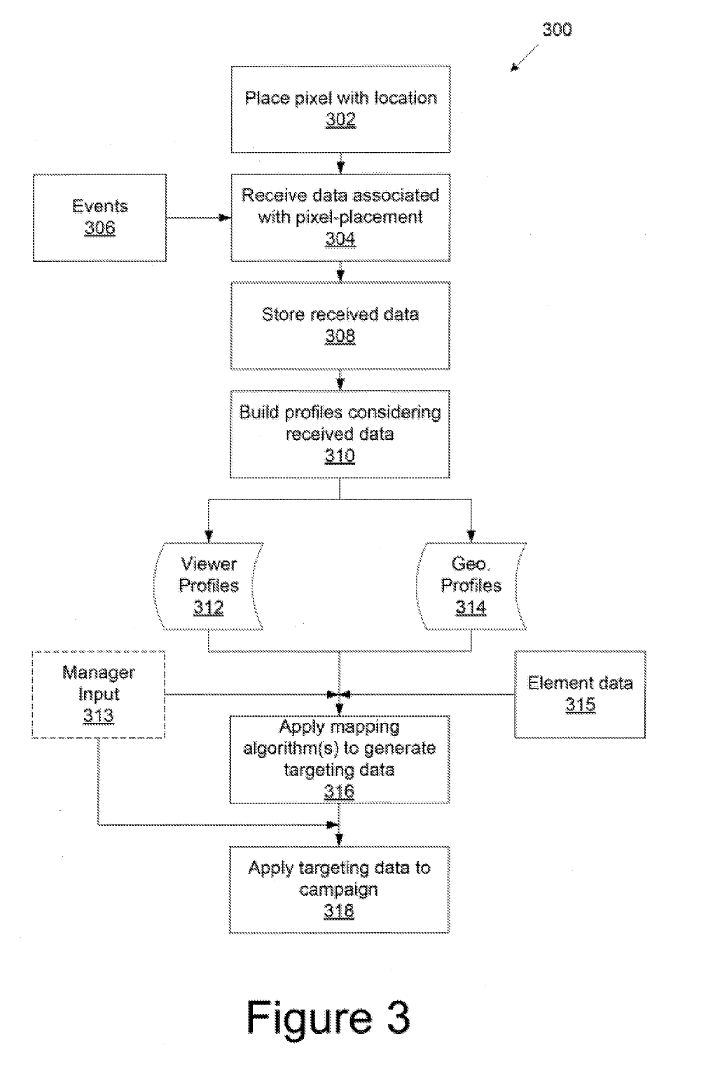

FIG. 3 is a flow chart showing one embodiment of a process flow 300 for generating one or more viewer profiles and mapping the viewer profiles to element data to identify elements-of-interest (e.g., elements that are likely to be of interest to viewers meeting one or more viewer profiles). Some or all of the actions described in conjunction with the process flow 300 may be performed by the targeting server 102 described herein (e.g., by the mapping module 202 and/or the profile assembly module 204).

Optional actions 302, 304, 306, 308 and 310 of the process flow 300 represent one non-limiting example embodiment for generating viewer profiles. Generally, the profile assembly module 204 tracks viewers of web sites associated with the content-to-be-delivered (e.g., the content-to-be-targeted) and obtains data regarding these viewers. The data is subsequently clustered into one or more viewer profiles, where each viewer profile describes attributes of viewers known or believed to have an interest in the content-to-be-delivered. In the example embodiment illustrated by FIG. 3, the viewers are tracked utilizing a tracking pixel. At 302, the profile assembly module 204 places the tracking pixel at a location believed to be viewed by viewers having an interest in the content-to-be-delivered. For example, the tracking pixel may be placed at a web site either in content provided by the web site and/or in advertising content provided through the web site.

When a viewer (e.g., via a viewer device 110) downloads content including the tracking pixel, the tracking pixel causes the viewer device 110 to direct a cookie request to the targeting server 102 or another suitable server. In response to the cookie request, the targeting server 102 or other suitable server may provide the cookie to the viewer device 110. Additionally, various data about the request may be stored and/or extrapolated including, for example, a network address associated with the request, a geographic location (e.g., zip code) associated with the request, etc. This data may be stored to the data store 104, for example, as tracking data 208. In some example embodiments, the tracking data may be stored as part of an enterprise data warehouse.

At 304, the profile assembly module 204 may receive additional data associated with a tracking pixel placement. For example, after a tracking pixel has caused a cookie to be placed on a viewer device 110, subsequent activities of the viewer device 110 (and the viewer using the device 110) may be tracked. Such activity, represented by box 306, may include, for example, the viewer device 110 being served an advertisement or other content provided by a server or servers in communication with the tracking server 102, the viewer clicking through such an advertisement or other content, the viewer converting such an advertisement or other content by performing a predetermined action on a third party web site (e.g., a site of the advertiser), etc. At 308, received data regarding viewer activity (e.g., tracking data 208) may be stored at the data store 104. Such received data may include data describing all of the viewers that downloaded the content including the tracking pixel. It will be appreciated, however, that viewers who perform relatively more subsequent activities (306) will be described by relatively more data than other viewers.

At 310, the profile assembly module 204 may generate one or more viewer profiles based on the received tracking data 208. Generally, the profile assembly module 204 may analyze the received data to identify common attributes of one or more viewer types that downloaded the original tracking pixel. Accordingly, in various embodiments, each viewer profile comprises one or more viewer attributes describing viewers believed to be interested in the content-to-be-delivered. A profiling algorithm may be applied to the received data to generate the profiles. The profiling algorithm may be and/or comprise any suitable algorithm including, for example, a decision tree, a neural network, a clustering algorithm, etc. Various different kinds of viewer profiles may be generated. For example, some viewer profiles, such as viewer profile 312 in FIG. 3, may be general and may include all available activity, demographic, geographic, etc., attributes describing the viewer type. Other viewer profiles may focus on a particular type of attribute. For example, geography-based profiles, such as profile 314 in FIG. 3, may focus on factors that are related to and/or derived from geography such as, for example, location, age data describing people at the location, income data describing people at the location, gender data describing people at the location, etc.

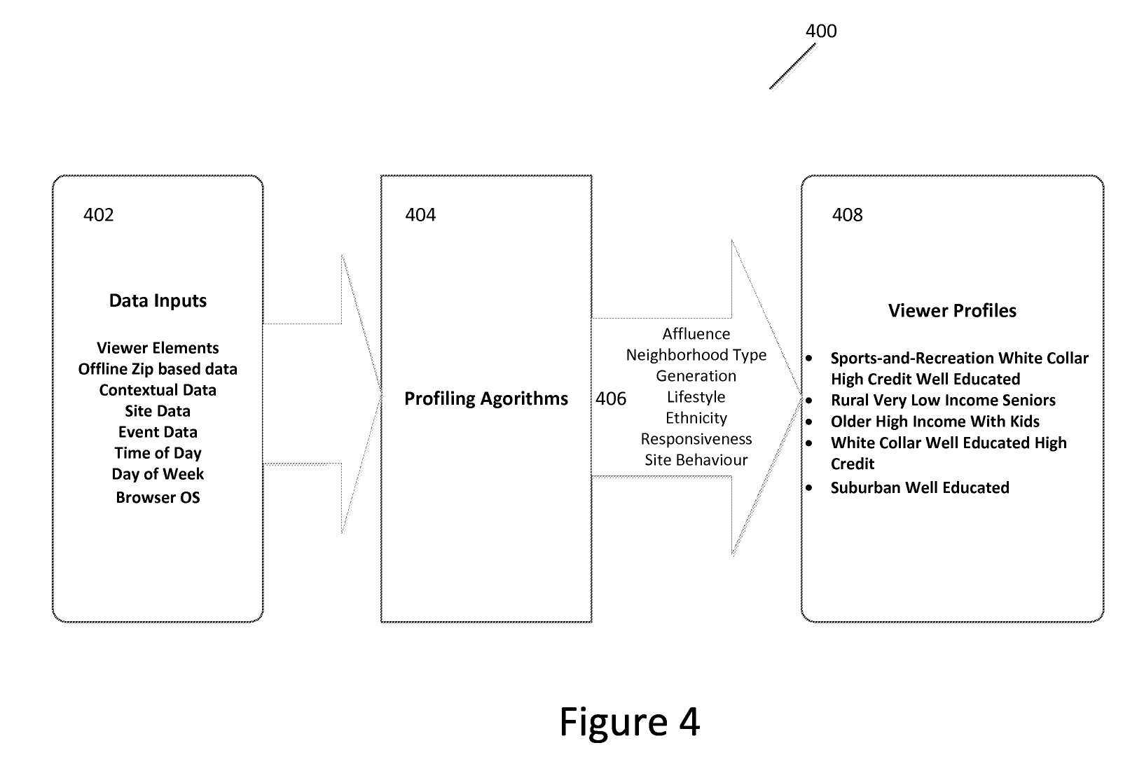

FIG. 4 is a diagram showing a workflow 400, according to one embodiment, for viewer profile generation illustrated in the process flow 300, including examples of data types. Data inputs box 402 shows example viewer data that may be provided to generate viewer profiles. This data may include the data received from tracking viewers as described above. For example, viewer element data may indicate elements that a viewer “likes” or otherwise indicates an interest. Offline zip or zip code-based data may indicate general demographic data describing people who live in the same geographic area as a viewer (e.g., as derived from the viewers network address). Site data may describe web sites that the viewer visits after placement of the cookie, as described herein. Event data may describe things that the viewer does after placement of the cookie including, for example, being served an advertisement or other content, clicking through the advertisement or other content, converting the advertisement or other content, etc. Time of day and day of week data may indicate the times and dates at which the viewer performs the various activities described herein. Brower and operating system (OS) may describe particulars of the viewer device 110 being used by a viewer. Examples of suitable web browsers that may be used by different viewers include MICROSOFT INTERNET EXPLORER, GOOGLE CHROME, MOZILLA FIREFOX, APPLE SAFARI, GOOGLE ANDROID, etc. Examples of suitable operating systems that may be used by viewers include MICROSOFT WINDOWS operating systems, APPLE OS operating systems, Linux-based operating systems, APPLE iOS, GOOGLE ANDROID, etc. Collectively, the data indicated at box 402 may make up all or a portion of the tracking data 208 described above.

Box 404 represents the application of one or more profiling algorithms to tracking data 208, for example, as described above with respect to 310. Results of the application of the profiling algorithms may include one or more viewer profiles, examples of which are illustrated at box 408. Arrow 406, between boxes 404 and 408, lists examples of attribute types that may be used to describe the various viewer profiles. Affluence attributes may indicate net worth, annual income, etc., and may be derived from viewers' geographic locations as well as from behavioral or other data. Neighborhood type attributes may also be derived from the viewers' geographic locations as well as from behavioral or other data. Generation attributes may describe viewers' ages and may be derived from the viewers' geographic locations and/or other activities of the viewer (e.g., types of web sites visited and/or advertisements engaged with, etc.). Responsiveness and site behavior attributes may describe the way that viewers' interact with various web sites and advertising content.

Referring back to FIG. 3, at 316, the mapping module 202 may apply a mapping algorithm to combine the one or more viewer profiles with element data 315 to identify elements-of-interest. As described herein, the element data may describe a plurality of elements, with each element described by at least one demographic tag and an indication of relevance. The mapping algorithm may be and/or include any suitable algorithm including, for example, an expert system-based algorithm, a data mining algorithm, a neural network algorithm, a statistical algorithm, an association algorithm, a heuristic-based algorithm, a search algorithm, a tabular mapping algorithm, etc. In some example embodiments, mapping each viewer profile onto the plurality of elements may comprise identifying elements from the plurality of elements having demographic tags describing attributes that overlap with attributes of the viewer profile (e.g., common attribute elements). The identified elements (e.g., matching elements) may be sorted based on their relevance. In some embodiments, elements may have distinct relevance scores based on demographic tags. For elements having multiple relevance scores, the relevance score relating to the selected demographic profile or profiles may be used. Matching elements having relevance above a threshold may be returned as elements-of-interest relative to the viewer profile. In some example embodiments, indicated by 313, a human campaign manager may review and select the viewer profiles that are the subject of to the mapping at 316.

In some example embodiments, common attribute elements may be grouped into sets by element type. Elements in a common set may be assigned a rank based on relevance. Example element sets may include product/brand elements, popular culture elements, geographic elements, etc. (See 512, 514, 516 at FIGS. 5 and 9). It will be appreciated, however, that element sets may be defined at any suitable level of granularity. For example popular culture-type elements may also grouped into sets including, movies, sports teams, football players, etc.

Optionally, at 318, the mapping module 202 may apply targeting data (e.g., the elements-of-interest) to one or more campaigns. For example, the mapping module 202 may automatically purchase the right to provide the content-to-be-delivered to viewers of one or more of the social media providers 108 that have “liked” or otherwise indicated interest in the elements-of-interest. In some embodiment, the manager 313 may review the elements-of-interest before such a purchase is made.

FIG. 5 is a diagram showing a workflow 500, according to one embodiment, for generating one or more viewer profiles and mapping the viewer profiles to element data to identify elements-of-interest. Box 502 represents and advertiser or other web site where a tracking pixel 504 may be placed, as described above. Data collected as a result of the tracking pixel 504 (e.g., tracking data 208) is stored at an enterprise data warehouse 506, that may be part of the data storage 104 described above. Profiling algorithms 508 are applied to the tracking data 208 to generate viewer profiles 510, as described herein above with respect to 310. In the example embodiment illustrated in FIG. 5, viewer profiles 510 are mapped to various different elements to generate targeting data 520, which includes element-of-interest. Various different types of elements are illustrated in FIG. 5, with each type optionally stored at different databases. Product/brand elements 512 describe products and/or brands that the viewers may like and/or patronize. Popular culture elements 514 describe popular culture elements such as movies, cars, music, performers, actors, and other people and things that viewers may like. Geographic elements 516 describe geographic areas that may be correlated to the viewer based on the selected profiles. FIG. 5 also illustrates a demographic database 518 that may store demographic data describing viewers and potential viewers. The targeting data 520 may be provided to a social media platform at 522, for example, as described herein above with respect to 318.

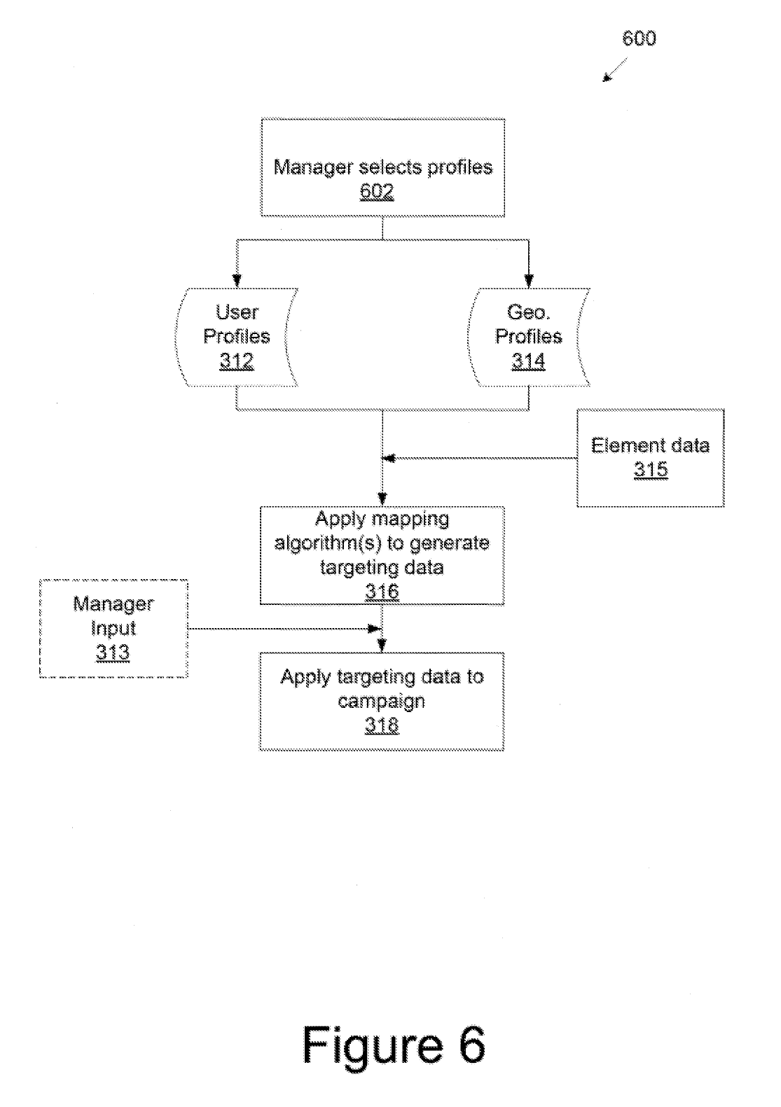

FIG. 6 is a flow chart showing one embodiment of a process flow 600 for mapping one or more viewer profiles to element data to identify elements-of interest. In the embodiment illustrated by FIG. 6, pre-generated user profiles are utilized. In some embodiments, the pre-generated user profiles may have been created as described above with respect to FIGS. 3 and 4. At 602, a campaign manager or other personnel select viewer profiles for inclusion in the process flow 600. For example, the campaign manager may know the content-to-be-delivered and make an educated guess as to the viewer profiles that would have interest in the content. The campaign manager may create the viewer profiles manually (e.g., by adding viewer attributes to the profiles) and/or may select viewer profiles from a set of pre-generated profiles. The remainder of the process flow 600 may operate in a manner similar to that of the process flow 300 described above.

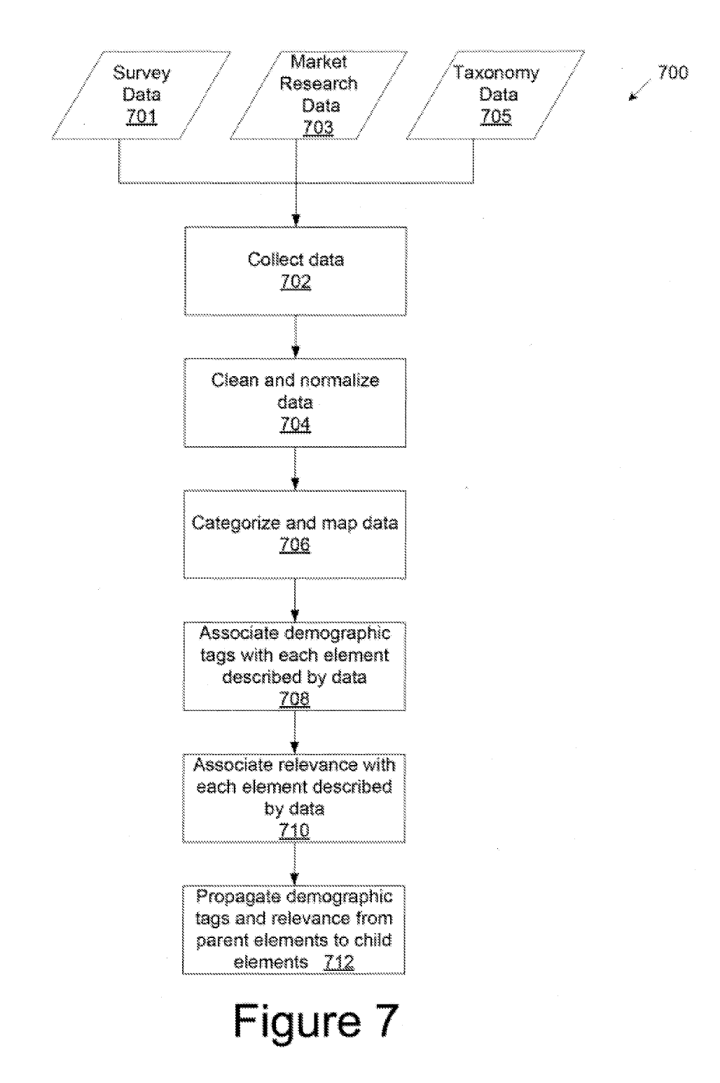

FIG. 7 is a flow chart showing one embodiment of a process flow 700 for generating elements, as described herein. In some example embodiments, the process flow 700 is executed by the targeting server 102 (e.g., the element assembly module 206 thereof). At 702, the targeting server may receive and/or collect data for generating the elements. The data may describe different elements that may be liked by and/or describe different viewers and may be received from various different sources. For example, the data may include survey data 701 received from surveys. The surveys may be provided to viewers and/or other individuals in any suitable context. For example, surveys may be provided to viewers in the course of providing other content (e.g., advertising content) to the viewers. Also, survey data may be purchased from third party data aggregators. In some example embodiments, the surveys include questions that gather demographic information about the surveyed individual as well as information about elements that are of interest to the individual. Demographic questions may include, for example, questions regarding age, gender, zip code, income level, education level, etc. Element questions may include questions about what types of movies, sports and other recreational activities are of interest to the individual, what types of products or services the individual purchases, etc. Market research data 703 may include data collected about individual consumers. The data may include different types of demographic as well as element-related information about individuals, typically by geographic area. Market research data 703 can be collected by the targeting server 102 and/or purchased from a third party source. Many third-party sources offer market research data delineated by geographic census block.

Taxonomy data 705 describes relationships between different elements (e.g., elements collected via survey data, market research data, etc. Taxonomy data may be generated in any suitable manner. For example, taxonomy data may be generated manually. Manual actors may scan popular culture sources such as, for example, newspapers, magazines, television shows, etc. and create groupings of elements and relationships between elements (e.g., actors, directors, other artists, and even other movies or cultural elements associated with movies, etc.). Also, in some embodiments, taxonomy data generation may be automated. For example, the element assembly module 206 may automatically generate elements and/or relationships from elements. Although survey data 701, market research data 703 and taxonomy data 705 are described, it will be appreciated that additional data from additional sources may also be received and considered.

At 704, the element assembly module 206 may clean and normalize the data 701, 703, 705. Data from different sources often refers to common elements or other concepts in different ways. For example, people's names may have multiple forms: (e.g., “John Kennedy,” “john F. Kennedy,” “John Fitzgerald Kennedy,” “Jack Kennedy,” etc.). The element assembly module 206 may utilize various algorithms to recognize common data entries in multiple forms and normalize the entries. Cleaning the data may comprise removing and/or normalizing data headers, removing and/or fixing corrupt data, etc.

At 706, the element assembly module 206 may categorize and map the data 701, 703, 705, Mapping the data may comprise generating and/or supplementing dependency relationships between elements. In some example embodiments, the element assembly module 206 may supplement dependency relationships that are received as a part of the taxonomy data. In some example embodiments, the module 206 may refer to databases of common popular culture items such as movies, sports teams and figures, etc. to identify related elements. For example, the module 206 may supplement the element “New York Giants” by identifying players, coaches, owners, and other people and/or things associated with the “New York Giants.” In some embodiments, elements may be segregated into sets by type, as described above. For example one group of elements may relate to products or brands, such as product/brand elements 512. Another group of elements may relate to popular culture items such as the popular culture elements 514 above.

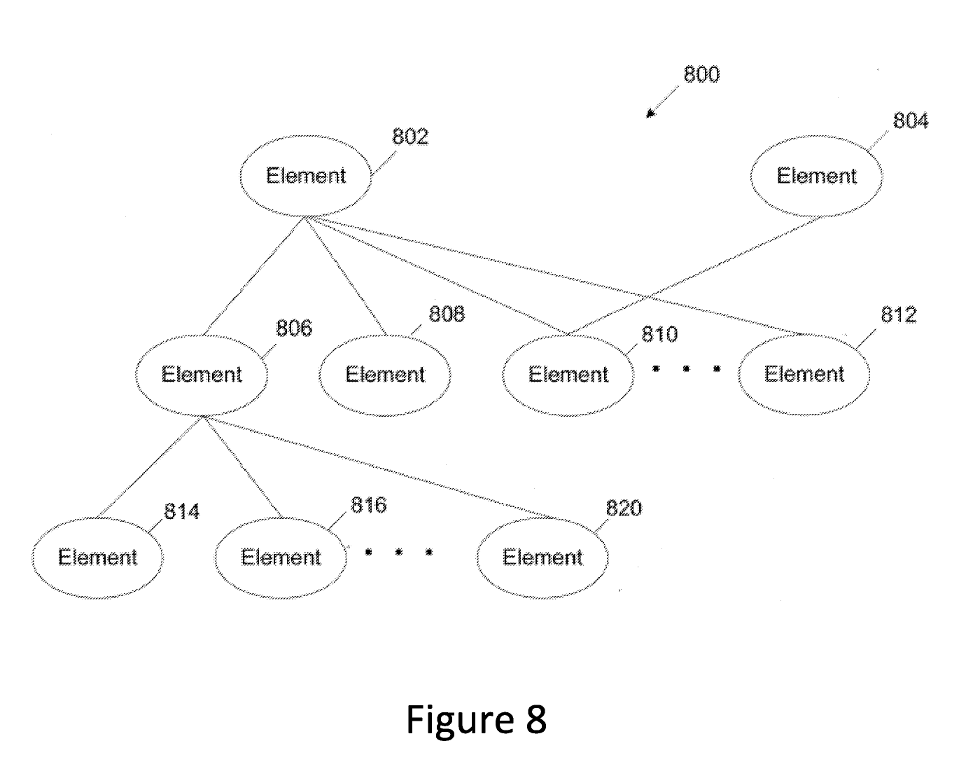

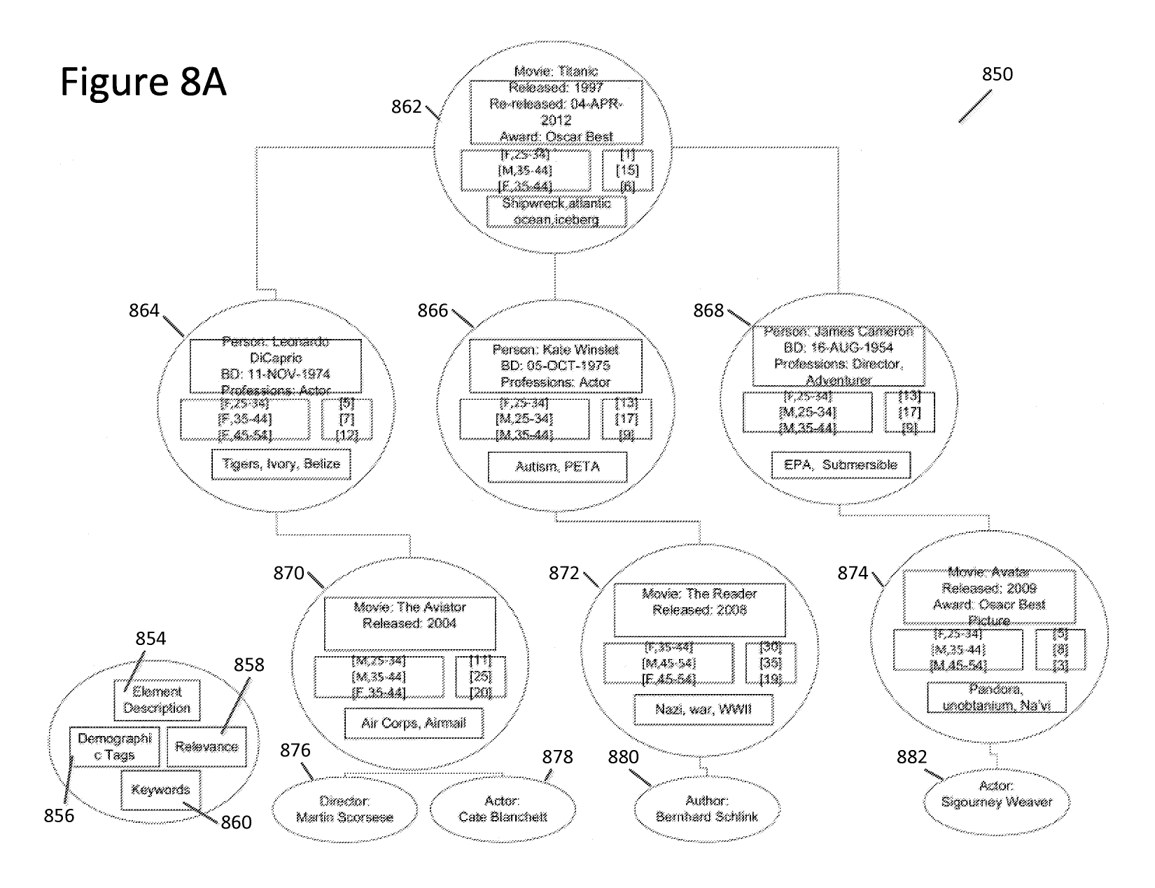

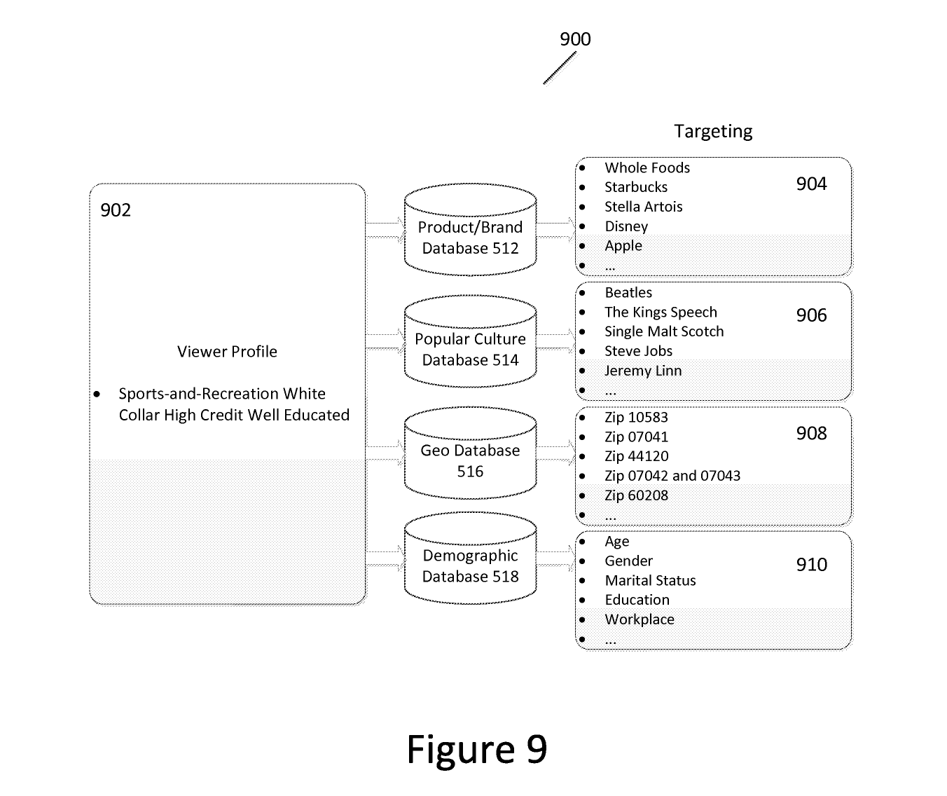

The result of the mapping may be a hierarchy of elements with dependencies there between. FIG. 8 is a diagram showing one example embodiment of a hierarchy 800 of elements. In the illustrated example, elements 806, 808, 810 and 812 depend from element 802. As shown, some elements may depend from more than one element. As illustrated, element 810 depends from both element 802 and from element 804. An example of this situation may be actors who have acted in multiple movies. The element “Leonardo DiCaprio” may depend from “Titanic” as well as from “The Aviator,” for example, as illustrated below in FIG. 8A. Also, as illustrated, elements may both have dependent elements and depend from another element themselves. In FIG. 8, elements 814, 816, 820 depend from element 806, which itself depends from element 802. For example, the element “National Football League” may have dependent elements for each team. Individual teams, however, may also have dependent elements (e.g., coaches, players, etc.).

Referring back to FIG. 7, at 708, the element assembly module 206 may associate demographic tags with various elements. As described above, each demographic tag may indicate an attribute or attributes of a viewer with a potential interest in the element. Demographic tags may be associated with elements based on the received data. For example, survey” data 701 and/or market research data 702 may link elements to demographic data. In some example embodiments, elements may also be associated with one or more keywords, as described herein.

At 710, the element assembly module 206 may associate a relevance with various elements. The relevance for an element indicates a general likelihood that viewers having an interest in the element will “like” the element or otherwise indicate their interest. Relevance may be expressed, for example, as a numerical score. Relevance for an element may be determined in any suitable manner. For example, the element assembly module 206 may access databases or other data sources providing information about current popular culture events (e.g., a news feed, the BILLBOARD HOT 100 list, various sources for movie box-office results, sporting news feeds, etc.). Elements that are featured in or related to current popular culture events may be assigned a higher relevance. As described above, relevance may be time-based and can be set to decay after the occurrence of events tending to draw attention to the element (e.g., the release of a movie, the success of a sports team, the anniversary of an event related to the element, etc.). In some example embodiments, relevance decay may be set to occur automatically, for example, based on a mathematical function. Any suitable function may be used including, for example, a linear function, an exponential function, a logarithmic function, etc.). In some example embodiments, relevance may be specific to a demographic tag or tags. For example, the element may have a first relevance with respect to a first demographic group and a second relevance with respect to a second demographic group.

At 712, the element assembly module 206 may propagate demographic tags and relevance from parent elements to dependent elements. Keywords, when used, may also be propagated. In some embodiments, propagating demographic tags from parent to dependent elements involves simply copying tags from the parent to the dependent element. If an element depends from more than one parent, such as element 810 in FIG. 8, then it may receive the demographic tags of both parents (802 and 804 in FIG. 8). Also, some elements may have demographic tags independent of any parent elements (e.g., demographic tags assigned at 708 as described above). Relevance may be similarly propagated from parent to dependent elements. In some embodiments, relevance may be degraded between parent and dependent nodes. For example, not every viewer that indicates an interest in “Titanic” will also indicate an interest in “Leonardo DiCaprio.” The degradation of relevance between parent and dependent nodes may be calculated in any suitable manner and, in some cases, may be determined on a case-by-case basis in view of the input data 701, 703, 705. In some example embodiments, the relevance degradation between a parent element and a dependent element may be based on a strength of dependency between the parent and dependent element. The strength of dependency may be input manually and/or may be calculated (e.g., by the element assembly module 206) based on review of the element data 212.

In some example embodiments, the element assembly module 206 performs an optional relevance update after assembly of the elements (e.g., including the dependencies between elements). According to the relevance update, the element assembly module receives additional data that may affect the relevance of one or more of the generated elements. The element assembly module may update the elements having a relevance affected by the new data and propagate any relevance changes to the relevant dependent elements, for example, as described herein above.

FIG. 8A is a diagram showing another example embodiment of a hierarchy 850 of elements. In FIG. 8A, each element may be described by an element name 854, which may also include additional information about the element, demographic tags 856, relevance 858 and keywords 860. Keywords 860, in example embodiments, are words that are associated with the element including, for example words that potentially return the element in a keyword search. Example element 862 is the movie “Titanic.” The element description, as illustrated, includes a release date, a re-release date, and an award won by the element. Example demographic tag data for “Titanic” 862 includes three groups, females 25-34, males 35-44 and females 35-44. Each demographic tag may comprise a corresponding relevance score. For example, the relevance score indicated in FIG. 8A for females 25-34 is [1]. Keywords associated with “Titanic” in the example of FIG. 8A include, “shipwreck,” “Atlantic,” “ocean,” and “iceberg.”

Additional elements Leonardo DiCaprio” 864, “Kate Winslet” 866 and “James Cameron” 868 depend from “Titanic” 862 and may include element descriptions, demographic tags, keywords, and relevance ratings similar to those of “Titanic” 862. The demographic tags and relevance of each of the elements 864, 866 and 868 may be propagated down from “Titanic” 862, at least in part, but may also depend on other parent elements and/or independent properties of the element. For example, the elements “Kate Winslet” 866, “Leonardo DiCaprio” 864 and “James Cameron” 868 all include properties (e.g., demographic tags, relevance and keywords) received at least in part from other parent elements (e.g., “The Aviator” 870 for “Leonardo DiCaprio” 864; “The Reader” 872 for “Kate Winslet” 866, and “Avatar” 874 for “James Cameron” 868. Additional child elements for elements 870, 872, and 874 are shown including “Martin Scorsese” 876 and “Cate Blanchett” 878 depending from “The Aviator” 870; “Bernhard. Schlink” 880 depending from “The Reader” 872; and “Sigoumey Weaver” 882 depending from “Avatar” 874. It will be appreciated that the various elements illustrated in FIG. 8A may have dependency relationships with additional elements that are not shown in FIG. 8A for reasons of space. Also, it will be appreciated that some elements may include keywords, demographic tags and/or relevance properties that are independent of dependency from another element. For example, “Kate Winslet” 866 includes the keywords “autism” and “Peta” due to an independent association between the actress Kate Winslet and those charities, and not necessarily because of a movie or other element from which “Kate Winslet” 866 depends.

FIG. 9 is a diagram showing an example implementation of a process for determining elements-of-interest based on a viewer profile. An example viewer profile 902 provides input to the process. The example viewer profile 902 is “sports-and-recreation white collar high credit well-educated.” The profile 902 may comprise a plurality of attributes tending to identify viewers meeting the profile. The profile 902 may be mapped across different types of elements 512, 514, 516, 518, as described herein, to produce different types of elements-of-interest. For example, elements-of-interest selected from product/brand elements 512 may include those listed at 904. Elements-of-interest selected from popular culture elements 514 may include those listed at 906. Elements-of-interest selected from geographic elements 516 may include those listed at 908 and elements of interest selected from demographic elements may include those listed at 910.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Reference in the specification to “one embodiment,” “an embodiment” “an example embodiment,” “some example embodiments,” “various example embodiments,” etc. means that a particular feature, structure, or characteristic described in-connection with the embodiments is included in at least one embodiment of the invention. Reference to embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated, it is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process instructions described herein in the form of a method. It should be noted that the process instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer or computer device selectively activated or reconfigured by a computer program stored in the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of tangible media suitable for storing electronic instructions, and each coupled to a computer system bus. Furthermore, the computers and computer systems referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to various example embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method comprising:
receiving, by a computer device comprising a processor and a memory in communication with the processor, at least one profile describing a viewer type likely to be interested in a first content;
receiving, by the computer device, a plurality of elements; and
determining, by the computer device, at least one element of the plurality of elements likely to be of interest to a potential viewer associated with the at least one profile by mapping the at least one profile to the plurality of elements.

2. The method of claim 1, wherein the at least one profile comprises geographical data.

3. The method of claim 1, wherein the at least one profile comprises web activity data.

4. The method of claim 1, wherein receiving the at least one profile comprises assembling the at least one profile based at least in part on use data describing a plurality of viewers of a first website associated with the first content.

5. The method of claim 4, wherein the use data is Obtained through tracking the plurality of viewers.

6. The method of claim 5, wherein tracking the plurality of viewers comprises storing a geographic location of a network address associated with a first viewer device of a first viewer of the plurality of viewers.

7. The method of claim 5, wherein tracking the plurality of viewers comprises:
providing a tracking pixel at the web site;
receiving a cookie request from the first viewer device that has downloaded the tracking pixel;
providing a cookie to the first viewer device; and
receiving information indicating that the first viewer device has performed at least one subsequent action, wherein the information identifies the first viewer device with the cookie.

8. The method of claim 7, wherein the at least one subsequent action comprises at least one action selected from the group consisting of:
viewing a second website;
receiving a second content;
clicking-through the second content to access additional content; or
converting the second content completing an action on a web site associated with the second content.

9. The method of claim 1, wherein receiving the at least one profile comprises assembling the at least one profile based at least in part on geographic data describing a location of the viewer.

10. The method of claim 9, wherein the geographic data comprises data describing at least one person living in the geographic location.

11. The method of claim 1, further comprising generating at least one element of the plurality of elements, wherein generating the at least one element comprises:
receiving element data describing the at least one element and a hierarchal relationship between the at least one element and a second element, wherein the second element depends from the at least one element;
receiving a demographic tag for the at least one element indicating a viewer type likely to be interested in the at least one element; and
propagating the demographic tag for the at least one element to first element to the second element.

12. The method of claim 11, wherein generating the at least one element further comprises:
receiving a first relevance data indicating a likelihood that a viewer type is likely to be interested in the at least one element; and
propagating the first relevance data to the second element.

13. The method of claim 12, wherein the first relevance data comprises a time-varying function, wherein the time-varying function is a function that decays over time.

14. The method of claim 11, wherein the second element also depends from a third element, and wherein generating the at least one element further comprises:
receiving a demographic tag for the third element, wherein the demographic tag for the third element indicates a viewer type likely to be interested in the third element; and
propagating the demographic tag for the third element to the second element.

15. The method of claim 11, wherein the second element also depends from a third element, and wherein generating the at least one element further comprises;
receiving a second relevance data indicating a likelihood that a viewer type is likely to be interested in the third element; and
propagating the second relevance data to the second element.

16. A computer readable medium comprising software program code executable by a processor to:
receive at least one profile describing a viewer type likely to be interested in a first content;
receive a plurality of elements; and
determine at least one element of the plurality of elements likely to be of interest to a potential viewer associated with the at least one profile by mapping the at least one profile to the plurality of elements.

17. The computer readable medium of claim 16, wherein the at least one profile comprises geographical data.

18. The computer readable medium of claim 16, wherein the at least one profile comprises web activity data.

19. The computer readable medium of claim 16, wherein receiving the at least one profile comprises assembling the at least one profile based at least in part on use data describing a plurality of viewers of a first website associated with the first content.

20. The computer readable medium of claim 19, wherein the use data is obtained through tracking the plurality of viewers.

21. The computer readable medium of claim 20, wherein tracking the plurality of viewers comprises storing a geographic location of a network address associated with a first viewer device of a first viewer of the plurality of viewers.

22. The computer readable medium of claim 20, wherein tracking the plurality of viewers comprises:
providing a tracking pixel at the web site;
receiving a cookie request from the first viewer device that has downloaded the tracking pixel;
providing a cookie to the first viewer device; and
receiving information indicating that the first viewer device has performed at least one subsequent action, wherein the information identifies the first viewer device with the cookie.

23. The computer readable medium of claim 22, wherein the at least one subsequent action comprises at least one action selected from the group consisting of:
viewing a second website;
receiving a second content;
clicking-through the second content to access additional content; or
converting the second content completing an action on a web site associated with the second content.

24. The computer readable medium of claim 16, wherein receiving the at least one profile comprises assembling the at least one profile based at least in part on geographic data describing a location of the viewer.

25. The computer readable medium of claim 24, wherein the geographic data comprises data describing at least one person living in the geographic location.

26. The computer readable medium of claim 16, further comprising software program code executable by a processor to generate at least one element of the plurality of elements, wherein generating the at least one element comprises:
receiving element data describing the at least one element and a hierarchal relationship between the at least one element and a second element, wherein the second element depends from the at least one element;
receiving a demographic tag for the at least one element indicating a viewer type likely to be interested in the at least one element; and
propagating the demographic tag for the at least one element to first element to the second element.

27. The computer readable medium of claim 26, wherein generating the at least one element further comprises:
receiving a first relevance data indicating a likelihood that a viewer type is likely to be interested in the at least one element; and
propagating the first relevance data to the second element.

28. The computer readable medium of claim 27, wherein the first relevance data comprises a time-varying function, wherein the time-varying function is a function that decays over time.

29. The computer readable medium of claim 26, wherein the second element also depends from a third element, and wherein generating the at least one element further comprises:
receiving a demographic tag for the third element, wherein the demographic tag for the third element indicates a viewer type likely to be interested in the third element; and
propagating the demographic tag for the third element to the second element.

30. The computer readable medium of claim 26, wherein the second element also depends from a third element, and wherein generating the at least one element further comprises;
receiving a second relevance data indicating a likelihood that a viewer type is likely to be interested in the third element; and
propagating the second relevance data to the second element.

31. A system comprising:
a processor;
a memory in communication with the processor, the memory comprising computer program code executable by a processor to:
receive at least one profile describing a viewer type likely to be interested in a first content;
receive a plurality of elements; and
determine at least one element of the plurality of elements likely to be of interest to a potential viewer associated with the at least one profile by mapping the at least one profile to the plurality of elements.

32. The system of claim 31, wherein the at least one profile comprises geographical data.

33. The system of claim 31, wherein the at least one profile comprises web activity data.

34. The system of claim 31, wherein receiving the at least one profile comprises assembling the at least one profile based at least in part on use data describing a plurality of viewers of a first website associated with the first content.

35. The system of claim 34, wherein the use data is obtained through tracking the plurality of viewers.

36. The system of claim 35, wherein tracking the plurality of viewers comprises storing a geographic location of a network address associated with a first viewer device of a first viewer of the plurality of viewers.

37. The system of claim 35, wherein tracking the plurality of vie comprises:
providing a tracking pixel at the web site;
receiving a cookie request from the first viewer device that has downloaded the tracking pixel;
providing a cookie to the first viewer device; and
receiving information indicating that the first viewer device has performed at least one subsequent action, wherein the information identifies the first viewer device with the cookie.

38. The system of claim 37, wherein the at least one subsequent action comprises at least one action selected from the group consisting of:
viewing a second website;
receiving a second content;
clicking-through the second content to access additional content; or
converting the second content completing an action on a web site associate with the second content.

39. The system of claim 31, wherein receiving the at least one profile comprises assembling the at least one profile based at least in part on geographic data describing a location of the viewer.

40. The system of claim 39, wherein the geographic data comprises data describing at least one person living in the geographic location.

41. The system of claim 31, the memory further comprising computer program code executable by a processor to generate at least one element of the plurality of elements, wherein generating the at least one element comprises:
receiving element data describing the at least one element and a hierarchal relationship between the at least one element and a second element, wherein the second element depends from the at least one element;
receiving a demographic tag for the at least one element indicating a viewer type likely to be interested in the at least one element; and
propagating the demographic tag for the at least one element to first element to the second element.

42. The system of claim 41, wherein generating the at least one element further comprises:
receiving a first relevance data indicating a likelihood that a viewer type is likely to be interested in the at least one element; and
propagating the first relevance data to the second element.

43. The system of claim 42, wherein the first relevance data comprises a time-varying function, wherein the time-varying function is a function that decays over time.

44. The system of claim 41, wherein the second element also depends from a third element, and wherein generating the at least one element further comprises:
receiving a demographic tag for the third element, wherein the demographic tag for the third element indicates a viewer type likely to be interested in the third element; and
propagating the demographic tag for the third element to the second element.

45. The system of claim 41, wherein the second element also depends from a third element, and wherein generating the at least one element further comprises;
receiving a second relevance data indicating a likelihood that a viewer type is likely to be interested in the third element; and
propagating the second relevance data to the second element.
